(19) United States
(12) Patent Application Publication
(10) Pub. No.: US 2014/0185898 A1
(43) Pub. Date: Jul. 3, 2014

(54) IMAGE GENERATION METHOD AND APPARATUS

(71) Applicant: Samsung Electronics Co., Ltd., Suwon-si (KR)

(72) Inventors: Byung-kwan Park, Seoul (KR); Tae-yong Song, Hwaseong-si (KR); Jae-mock Yi, Hwaseong-si (KR)

(73) Assignee: SAMSUNG ELECTRONICS CO., LTD., Suwon-si (KR)

(21) Appl. No.: 14/059,766

(22) Filed: Oct. 22, 2013

(30) Foreign Application Priority Data
Dec. 28, 2012 (KR) 10-2012-0157336

(51) Int. Cl. G06T 7/00

(52) U.S. Cl. CPC G06T 7/0012
USPC 382/131

(57) ABSTRACT

An image generation method includes classifying data according to a motion period of an object; generating respective sinograms from the classified data; updating an intermediate sinogram for an intermediate image using the sinograms; generating an updated intermediate image by performing a back projection on the updated intermediate sinogram; and generating an image in which a motion of the object is compensated by sequentially applying the sinograms in a process of generating the updated intermediate image.

### CROSS-REFERENCE TO RELATED APPLICATIONS

This application claims the benefit of Korean Patent Application No. 10-2012-0157336 filed on Dec. 28, 2012, in the Korean Intellectual Property Office, the disclosure of which is incorporated herein by reference in its entirety for all purposes.

### BACKGROUND

1. Field

This disclosure relates to methods and apparatuses for generating an image of an object.

2. Description of Related Art

Medical imaging equipment for obtaining an image of the inside of a human body for use in diagnosing a patient provides information necessary to diagnose a disease. Medical image photographing methods currently used in hospitals or under development are largely divided into a method of obtaining an anatomical image and a method of obtaining an physiological image. Examples of photographing technologies that provide a detailed anatomical image of a human body having a high resolution may include magnetic resonance imaging (MRI) or computed tomography (CT). Such technologies show an accurate location and shape of an organ inside a human body by generating a two-dimensional (2D) image of a cross section of the human body or generating a three-dimensional (3D) image using several sheets of a 2D image to have a high resolution. A representative example of a physiological image photographing technology is positron emission tomography (PET) for photographing a metabolic process inside the human body, thus helping to diagnose whether there is an abnormality in the metabolism.

PET is a photographing technology that includes generating a special radiation tracer that emits a positron in the form of a component that participates in the metabolic process of a human body, and introducing the tracer into the human body using an intravenous injection or an inhaling method. When the positron emitted from the tracer combines with an electron, two gamma rays of about 511 keV are emitted in opposite directions to each other, and are detected using external equipment. Thus, a location of the tracer may be determined, and a distribution of the gamma rays and a change in their distribution according to time may be observed.

### SUMMARY

In one general aspect, an image generation method includes classifying data according to a motion period of an object; generating respective sinograms from the classified data; updating an intermediate sinogram for an intermediate image using the sinograms; generating an updated intermediate image by performing a back projection on the updated intermediate sinogram; and generating an image in which a motion of the object is compensated by sequentially applying the sinograms in a process of generating the updated intermediate image.

The generating of the updated intermediate image may include setting one of the sinograms as a reference sinogram; estimating a motion of remaining ones of the sinograms excluding the reference sinogram based on the reference sinogram; and converting the remaining sinograms by inversely applying the estimated motion to the remaining sinograms; wherein the updating of the intermediate sinogram may include updating the intermediate sinogram using the reference sinogram and the converted sinograms.

The estimating of the motion of the remaining sinograms may include estimating a degree by which a location of a center for each angle moves in the remaining sinograms relative to the reference sinogram.

The updating of the intermediate sinogram may further include comparing the intermediate sinogram with the reference sinogram or one of the converted sinograms; determining whether to update the intermediate sinogram based on a result of the comparing; and applying a ratio obtained from the result of the comparing to the intermediate sinogram.

The updating of the intermediate sinogram may further include determining that the updating of the intermediate sinogram is finished in response to the ratio being less than a predetermined threshold; and the generating of the image in which the motion of the object is compensated may include performing a back projection on the updated intermediate sinogram.

The generating of the respective sinograms may include obtaining the data from a detection unit; gating the data into 1st through nth groups of data according to the motion period of the object; and generating 1st through nth sinograms from the 1st through nth groups of data; and the generating of the updated intermediate image may include sequentially updating the intermediate sinogram using the 1st through nth sinograms.

The generating of the respective sinograms may include generating each of the respective sinograms from data of the classified data obtained when a state of the motion of the object is the same.

In another general aspect, a non-transitory computer-readable storage medium stores a computer for controlling a computer to perform the method described above.

In another general aspect, an image generation apparatus includes a sinogram generation unit configured to classify data according to a motion period of an object; and generate respective sinograms from the classified data; and an update unit configured to update an intermediate sinogram for an intermediate image using the sinograms; generate an updated intermediate image by performing a back projection on the updated intermediate sinogram; and generate an image in which a motion of the object is compensated by sequentially applying the sinograms in a process of generating the updated intermediate image.

The update unit may be further configured to set one of the sinograms as a reference sinogram; estimate a motion of remaining ones of the sinograms excluding the reference sinogram based on the reference sinogram; convert the remaining sinograms by inversely applying the estimated motion to the remaining sinograms; and update the intermediate sinogram using the reference sinogram and the converted sinograms.

The update unit may be further configured to estimate the motion of the remaining sinograms by estimating a degree by which a position of a center for each angle moves in the remaining sinograms relative to the reference sinogram.

The update unit may be further configured to update the intermediate sinogram by comparing the intermediate sinogram with the reference sinogram or one of the converted sinograms; determining whether to update the intermediate sinogram based on a result of the comparing; and applying a ratio obtained from the result of the comparing to the intermediate sinogram.

The update unit may be further configured to determine that updating of the intermediate sinogram is finished in response to the ratio being less than a predetermined threshold; and generate the image in which the motion of the object is compensated by performing a back projection on the updated intermediate sinogram.

The sinogram generation unit may be further configured to obtain the data from a detection unit; gate the data into 1st through nth groups of data according to the motion period of the object; and generate 1st through nth sinograms from the 1st through nth groups of data; and the update unit may be further configured to sequentially update the intermediate sinogram using the 1st through nth sinograms.

The sinogram generation unit may be further configured to generate each of the respective sinograms from data of the classified data obtained when a state of the motion of the object is the same.

In another general aspect, an image generation method includes obtaining data from an object; generating a plurality of sinograms respectively corresponding to different states of the object from the data; updating an intermediate sinogram based on one or more of the sinograms to obtain an updated intermediate sinogram; and generating an image by performing a back projection on the updated intermediate sinogram.

The image generation method may further include setting one of the sinograms as a reference sinogram; estimating a change in a state of remaining ones of the sinograms relative to a state of the reference sinogram based on the reference sinogram; and generating converted sinograms in which the change of the state is compensated by inversely applying the estimated change in the state to the remaining sinograms; and the updating of the intermediate sinogram may include sequentially updating the intermediate sinogram based on one or more of the reference sinogram and the converted sinograms.

The sequential updating of the intermediate sinogram may include comparing a latest updated intermediate sinogram produced by a latest updating of the intermediate sinogram in the sequential updating of the intermediate sinogram with a next one of the reference sinogram and the converted sinograms to be used in a next updating of the intermediate sinogram; and determining whether the sequential updating of the intermediate sinogram is finished based on a result of the comparing.

The comparing may include determining a ratio between the latest updated intermediate sinogram and the next one of the reference sinogram and the converted sinograms; and the determining may include determining that the sequential updating of the intermediate sinogram is finished in response to the ratio being less than or equal to a predetermined threshold.

The different states of the object may be different motion states of the object; and the generating of the image may produce an image that is compensated for the motion of the object.

Other features and aspects will be apparent from the following detailed description, the drawings, and the claims.

### BRIEF DESCRIPTION OF THE DRAWINGS

FIG. 1 is a diagram illustrating an example of an image generation system for generating an image of a cross-section of an object.

FIG. 2 a diagram for explaining an example of line-of-response (LOR) data.

FIG. 3 is a diagram for explaining an example of gating of data.

FIG. 4 is a diagram for explaining an example of generation of a sinogram for gated data.

FIG. 5 is a diagram illustrating an example of an image generation apparatus.

FIG. 6 is a diagram for explaining an example of a method of generating an image in which motion is compensated performed by the image generation apparatus of FIG. 5.

FIG. 7 is a flowchart for explaining an example of a method of generating an image in which motion is compensated performed by the image generation apparatus of FIG. 5.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent to one of ordinary skill in the art. The sequences of operations described herein are merely examples, and are not limited to those set forth herein, but may be changed as will be apparent to one of ordinary skill in the art, with the exception of operations necessarily occurring in a certain order. Also, description of functions and constructions that are well known to one of ordinary skill in the art may be omitted for increased clarity and conciseness.

Throughout the drawings and the detailed description, the same reference numerals refer to the same elements. The drawings may not be to scale, and the relative size, proportions, and depiction of elements in the drawings may be exaggerated for clarity, illustration, and convenience.

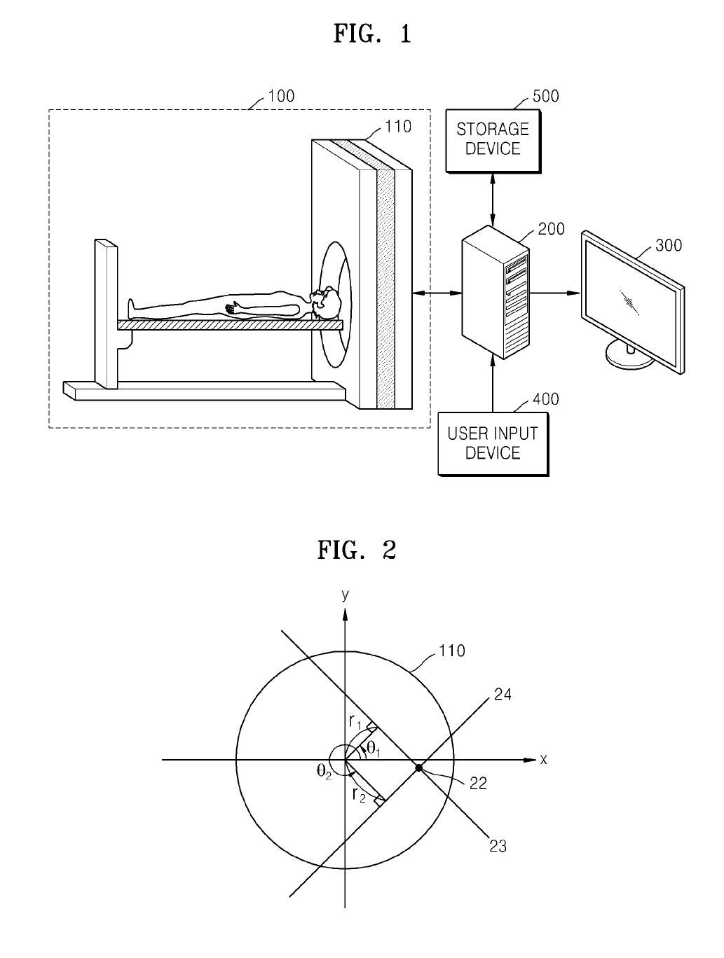

FIG. 1 is a diagram illustrating an example of an image generation system for generating an image of a cross-section of an object. Referring to FIG. 1, the image generation system includes an image photographing apparatus 100, a computer 200, a display device 300, a user input device 400, and a storage device 500.

The image generation system of FIG. 1 generates an image of a cross-section of an object. The image photographing apparatus 100 outputs data obtained by photographing the object to the computer 200. The computer 200 generates a medical image of the object based on the received data. The computer 200 may perform motion compensation for generating an image in which a motion blur caused by motion of the object is removed. The object may include a human body, or an organ, a tract, or a tissue of a human body. For example, the object may be a liver, a lung, or a heart, but the object is not limited thereto. If the object is an organ of a human body, a periodic motion such as a respiratory motion generated by respiration of a human body, or a motion generated by a heartbeat, may occur. Accordingly, the computer 200 performs motion compensation for removing noise generated by a motion of an object.

Additionally, the image generation system may generate a system response of a detection unit 110 used for image generation. The system response may represent a calibration model of the detection unit 110. When an image is generated using a signal obtained from the detection unit 110, the calibration model of the detection unit 110 is used to generate a high-resolution image or calibrate a low-resolution image to obtain a high-resolution image. An example of the calibration model may be a blur model for calibrating image diffusion.

In an example of generating an image of the object using the image generation system of FIG. 1, the image photographing apparatus 100 detects a signal emitted from a tracer introduced into the object. A tracer is used as a term for designating a substance that emits a positron. For example, the image photographing apparatus 100 detects two gamma rays that are emitted when a positron emitted from a positron-emitting substance introduced into an object combines with a nearby electron. The image photographing apparatus 100 transmits line-of-response (LOR) data for the detected gamma rays to the computer 200. The computer 200 generates an image of the object using the LOR data. The LOR data is data indicating a location of a line in space, and will be further described with reference to FIG. 2.

FIG. 2 is a diagram for explaining an example of line-of-response (LOR) data. Referring to FIG. 2, a positron is emitted from a tracer 22 located within the detection unit 110. When the emitted positron combines with an electron, the positron emits two gamma rays in directions 180° apart. Thus, the two gamma rays travel along one line in opposite directions. FIG. 2 is an example of detecting two lines 23 and 24. Referring to the line 23, when a perpendicular line is drawn from an origin inside the detection unit 110 to the line 23, a distance between the origin and the line 23 is r₁, and an angle therebetween is θ₁. Thus, LOR data for the line 23 is (r₁, θ₁). Likewise, referring to the line 24, when a perpendicular line is drawn from the origin inside the detection unit 110 to the line 24, a distance between the origin and the line 24 is r₂, and an angle therebetween is θ₂. Thus, LOR data for the line 24 is (r₂, θ₂). As such, when two or more pieces of the LOR data are obtained, a location of the tracer 22 may be determined from the LOR data. The image photographing apparatus 100 transmits the LOR data for the detected gamma rays to the computer 200. Then, the computer 200 may eventually determine a location of the tracer 22 from the LOR data.

The display device 300 displays a medical image or a blur model generated by the computer 200 on a display panel.

A user may input information necessary for operation of the computer 200 using the user input device 400. For example, the user may command a start or an end of operation of the computer 200 using the user input device 400.

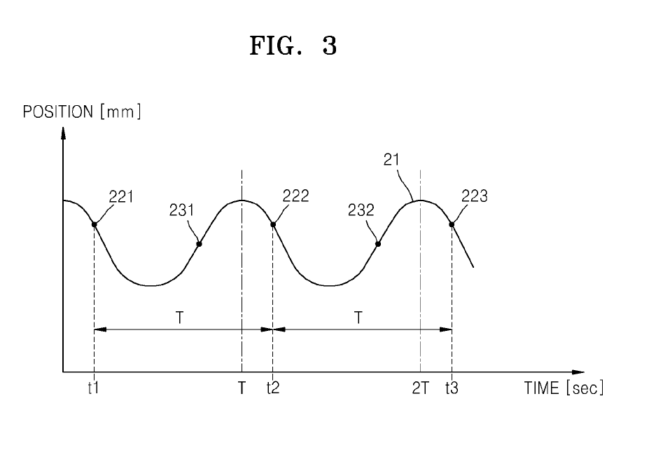

FIG. 3 is a diagram for explaining an example of gating of data. Referring to FIG. 3, a graph of FIG. 3 is an example of a signal 21 representing time information about each of a plurality of states according to a motion of an object. The signal 21 may be obtained from a device that is or is not in contact with the object.

The plurality of states according to a motion of an object correspond to a phase of the signal 21. For example, if a 1st state according to a motion of an object is defined as a 1st point 221 in a 1st period, a 2nd point 222 in a 2nd period that has the same phase as the first point 221 and a 3rd point 223 in a 3rd period that has the same phase as the 1st point 221 also correspond to the 1st state. Additionally, points 231 and 232 corresponding to a 2nd state according to a motion of the object may exist for each period. As such, points respectively corresponding to the plurality of states according to a motion of the object may exist for each period. Data obtained at points of time when a signal has the same phase according to a motion of an object may be classified into one group. Classification of data obtained in 1st through nth states into a group may be referred to as gating of data.

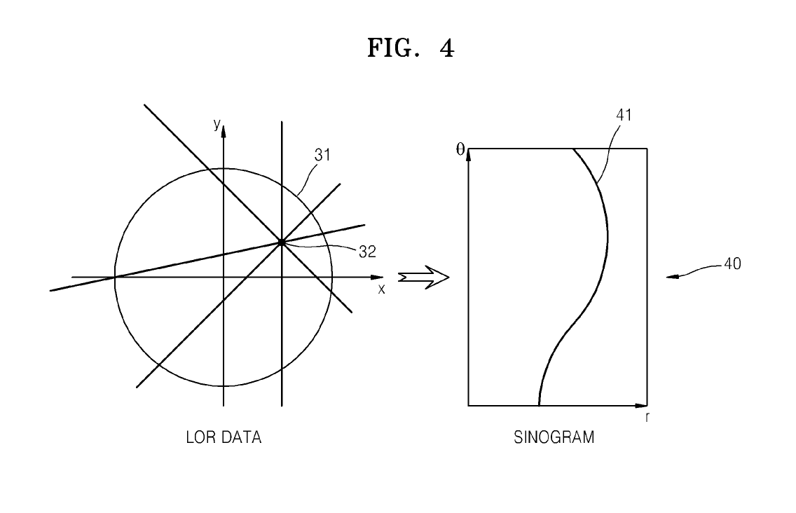

FIG. 4 is a diagram for explaining an example of generation of a sinogram from gated data. The gated data may be expressed in the form of a sinogram graph with r along a horizontal axis and θ along a vertical axis. The LOR data may be expressed as a sinogram graph with r along a horizontal axis and θ along a vertical axis. A process of expressing LOR data in the form of a sinogram is referred to as a forward projection. On the contrary, a process of converting a sinogram into LOR data is referred to as a back projection.

A graph 40 shows a sinogram of LOR data for several gamma rays emitted from a tracer 32 in a detection space of a detection unit 31. A point in a coordinate representing a location of the tracer 32 corresponds to a curve 41 in the graph of FIG. 4. Accordingly, if a plurality of tracers exist at different coordinates, sinograms of signals detected from such tracers may be shown as several curves.

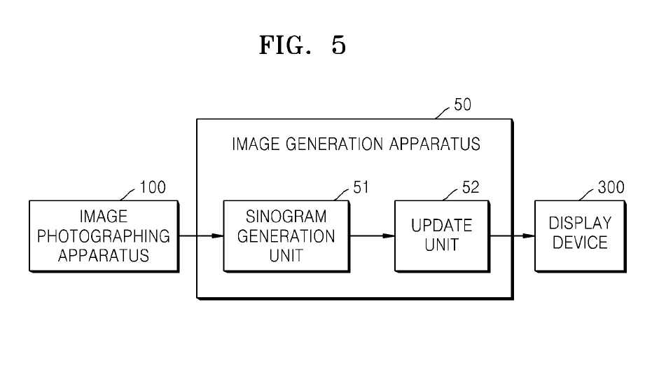

FIG. 5 is a diagram illustrating an example of an image generation apparatus. Referring to FIG. 5, the image generation apparatus 50 includes a sinogram generation unit 51 and an update unit 52. The image generation apparatus 50 creates an image in which motion is compensated using data input from the image photographing apparatus 100, and outputs the image in which motion is compensated to the display device 300.

The sinogram generation unit 51 obtains LOR data that includes information about two gamma rays from the image photographing apparatus 100. For example, the LOR data may include information such as a pair of detection elements that detect two gamma rays, an angle at which the gamma rays are incident on the detection unit, a distance from a gamma ray-emitting point to the detection unit, and a time at which two gamma rays are detected. The angle at which the two gamma rays are incident on the detection unit may be a projection angle of measurement data obtained from the object, and the distance from a gamma ray-emitting point to the detection unit may be a displacement of the measurement data obtained from the object. As such, the sinogram generation unit 51 obtains raw data such as the LOR data from the object and generates a sinogram from the obtained raw data.

The sinogram generation unit 51 classifies data into groups according to a period of a motion of the object, and generates a sinogram from each group of classified data. The classified data in each group is data obtained when a motion state of the object is the same. The classified data may be obtained by gating the input data.

The sinogram generation unit 51 obtains data from the detection unit 100 of the image photographing apparatus 100, gates the data into 1st through nth groups of data according to a motion period of the object, and generates 1st through nth sinograms from the 1st through nth groups of data. Accordingly, the 1st through nth sinograms do not include a blur caused by a motion of the object. In other words, if the first sinogram for one of a plurality of states according to a respiration motion of the object is generated, states of the object in one period of respiration are similarly repeated in every period of respiration. If the period of respiration of the object is about 1 period/5 sec, a state of the object is similar at 1, 6, and 11 seconds, and also similar at 2, 7, 12 seconds. The sinogram generation unit 51 generates a 1st sinogram from the data obtained when a detection time is at 1, 6, and 11 seconds, and generate a 2nd sinogram from the data obtained when a detection time is at 2, 7, and 12 seconds. 3rd through nth sinograms may be generated in the same manner.

Referring to FIG. 3, the sinogram generation unit 51 generates a first sinogram from data that corresponds to a point of time at which the signal 21 has a predetermined phase among data obtained from the object. If the sinogram generation unit 51 generates the first sinogram for a first state among a plurality of states according to a motion of the object, the sinogram generation unit 51 generates the first sinogram from data respectively corresponding to a first time t₁ corresponding to the first point 221, a second time t₂ corresponding to the first point 222, and a third time t₃ corresponding to the first point 223. For example, the data corresponding to the first time t₁ is data detected from the object at the first time t₁. The difference between the first time t₁ and the second time t₂, and the time difference between the second time t₂ and the third time t₃, are similar to a period T of the signal 21.

Time information for one state may be obtained from a device that is or is not in contact with the object, or from data obtained from the object. If the time information is obtained from a device that is or is not in contact with the object, the sinogram generation unit 51 may use electrocardiogram information or an infrared (IR) tracker, for example.

The update unit 52 updates an intermediate sinogram of an intermediate image using the sinograms, and performs a back projection on the updated intermediate sinogram, thus generating an updated intermediate image. The update unit 52 receives the sinograms from the sinogram generation unit 51. The update unit 52 sequentially uses the received sinograms to update the intermediate sinogram. That is, the update unit 52 sequentially applies the sinograms in a process of generating the updated intermediate image, thus generating an image in which motion is compensated. The intermediate image is an arbitrary image that is set on which an iterative-reconstruction algorithm is to be performed. The arbitrary image is obtained from the image photographing apparatus 100 or in-advance stored in the image generation apparatus 50. The arbitrary image may be an image of a human body, an organ, a tract or a tissue of a human body. And the arbitrary image may be an general model of an organ, a tract or a tissue of a human body. The intermediate sinogram is a sinogram generated by performing a forward projection on the intermediate image. By updating the intermediate sinogram, the update unit 52 may perform an iterative-reconstruction algorithm more efficiently than by updating the intermediate image.

The update unit 52 sets one of the sinograms received from the sinogram generation unit 51 as a reference sinogram, and based on the reference sinogram, estimates a motion of remaining sinograms excluding the reference sinogram. For example, the update unit 52 may find a block of a remaining sinogram that is most similar to a certain block of the reference sinogram, and compares the locations of the two blocks, thus estimating a motion of the remaining sinogram. Additionally, the update unit 52 may estimate a motion based on a degree by which a position of a center for each angle moves in the sinogram. The update unit 52 may also estimate a motion by modeling sinograms with a spline and using a difference between the models. Spline modeling refers to transformation of the sinogram into a simple form.

The update unit 52 converts the remaining sinograms by inversely applying the estimated motion to the remaining sinograms. For example, if it is determined that a remaining sinogram moves to the right compared to the reference sinogram, the motion of the remaining sinogram may be compensated by moving the remaining sinogram to the left to convert the remaining sinogram.

The update unit 52 generates an intermediate sinogram by performing a forward projection on the intermediate image, and updates the intermediate sinogram using the reference sinogram and the converted sinograms. For example, the update unit 52 may update the intermediate sinogram by comparing the intermediate sinogram with the reference sinogram or one of the converted sinograms, and applying a ratio obtained as a result of the comparison to the intermediate sinogram. The update unit 52 updates the intermediate image by updating the intermediate sinogram.

The update unit 52 determines whether to update the intermediate sinogram based on a result of the comparison. For example, if a difference between the reference sinogram or the converted sinogram and the intermediate sinogram is greater than a predetermined threshold, the update unit 52 may update the intermediate sinogram, and if the difference between the reference sinogram or the converted sinogram and the intermediate sinogram is less than or equal to the predetermined threshold, the update unit 52 may finish the update. When the update is finished, the update unit 52 generates a final image by performing a back projection on the updated intermediate sinogram. The generated final image is an image in which motion is compensated.

The following Equation 1 is an example of a method of updating an intermediate sinogram using a converted sinogram, and performing a back projection on the updated intermediate sinogram to obtain an intermediate image.

$${n}_{j}^{k + 1} = \frac{{n}_{j}^{k}}{{\sum }_{i}^{I} {a}_{ij}} {\sum }_{i}^{I} {a}_{ij} \frac{{X}_{k + 1} {m}_{i}^{k + 1}}{{\sum }_{i}^{I} {a}_{ij} {n}_{j}^{k}} \qquad ( 1 )$$

In Equation 1, nⱼ^{k} is an expected value of radiation emitted from a jth voxel of an image, and represents a value of a voxel of an intermediate image in a kth updating process. nⱼ^{k+1} is a value of a voxel of an intermediate image in a k+1th updating process. aᵢⱼ is a probability of detecting LOR data i at a jth voxel. Xₖ₊₁ is a converted sinogram used in the k+1th updating process. m^{k+1} is the number of radiations detected in LOR data i.

The sinogram generation unit 51 or the update unit 52 illustrated in FIG. 5 may correspond to a processor or a plurality of processors. The processor or processors may be implemented as an array of a plurality of logic gates, or may be implemented as an integration of a general-use microprocessor and a memory in which a program that may be executed on the microprocessor is stored. Additionally, it will be understood by one of ordinary skill in the art that the processor or processors may also be implemented as a different form of hardware.

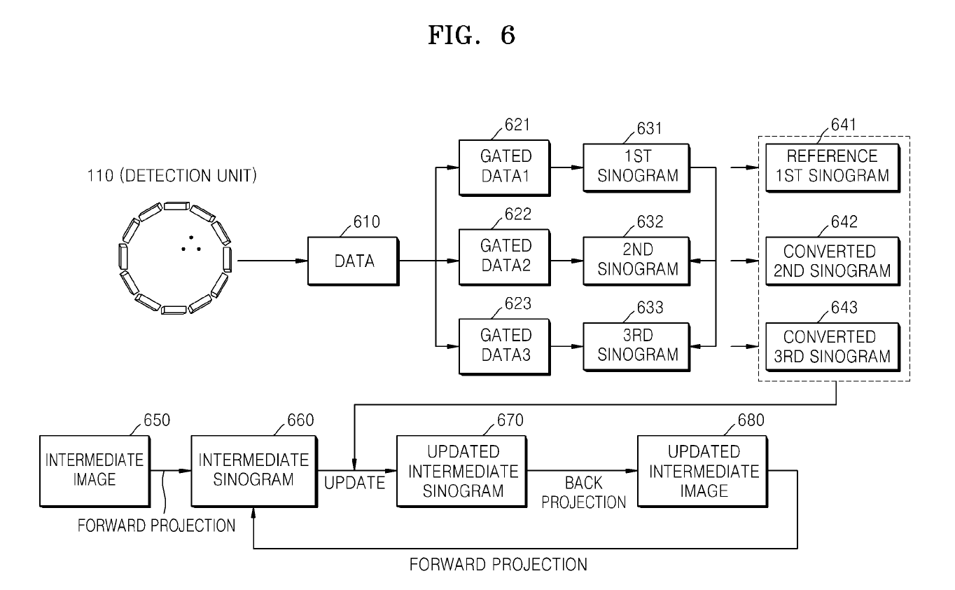

FIG. 6 is a diagram for explaining an example of a method of generating an image in which motion is compensated performed by the image generation apparatus of FIG. 5. The detection unit 110 obtains a signal generated in a detection area. The detection area of the detection unit 110 has a form of a cylinder as illustrated in FIG. 1. The signal is a signal emitted from a point source located in the detection area, or a signal emitted from an object into which a tracer is introduced.

In a case of a positron-emission tomography (PET) apparatus, the signal may be two gamma rays emitted when a positron emitted from a positron-emitting substance introduced into a physical body of an object combines with a nearby electron.

Data 610 is generated based on the obtained signal. For example, if the data 610 is LOR data, the LOR data may include information such as a pair of detection elements that detect two gamma rays, an angle at which the gamma rays are incident on the detection unit, a distance from a gamma ray-emitting point to the detection unit, and a time at which two gamma rays are detected.

The data 610 is gated into a plurality of gated data 621 through 623. In FIG. 6, the data 610 is gated into 3 groups of gated data 621 through 623, but the data 610 may be gated into more 3 groups of gated data.

The gated data 621 through 623 are respectively converted into 1st through 3rd sinograms 631 through 633. The 1st sinogram 631 may be set as a reference 1st sinogram 641. Based on the reference 1st sinogram 641, the remaining sinograms 632 and 633 excluding the sinogram 631 set as the reference 1st sinogram 641 are converted to obtain a converted 2nd sinogram 642 and a converted 3rd sinogram 643. FIG. 6 shows an example of setting the 1st sinogram 631 as the reference 1st sinogram 641, but any one of the sinograms 631 through 633 may be set as a reference sinogram.

The sinograms 631 through 633 are generated based on data obtained at points of time at which states of the object are different. Accordingly, by converting the remaining sinograms based on the reference sinogram, motion of the remaining sinograms relative to the reference sinogram may be compensated to a obtain converted sinograms corresponding to sinograms obtained when the states of the object are the same.

An arbitrary image is set as intermediate image 650. An intermediate sinogram 660 is generated by performing a forward projection on the intermediate image 650. The intermediate sinogram 660 is sequentially updated using the reference 1st sinogram 641, the converted 2nd sinogram 642, and the converted 3rd sinogram 643. First, the intermediate sinogram 660 is updated using the reference 1st sinogram 641 to obtain an updated intermediate sinogram 670, and a back projection is performed on the updated intermediate sinogram 670 to obtain an updated intermediate image 680. Then, a forward projection is performed on the updated intermediate image 680 to obtain an updated intermediate sinogram that is set as the intermediate sinogram 660, and the intermediate sinogram 660 is updated using the converted 2nd sinogram 642 using the same process described above. Then, a forward projection is performed on the updated intermediate image 680 to obtain an updated intermediate sinogram that is set as the intermediate sinogram 660, and the intermediate sinogram 660 is updated using the converted 3rd sinogram 643 using the same process described above.

In FIG. 6, a process of updating three times using the 1st through 3rd sinograms 631 through 633 is described. However, the number of times of updating may vary with the number of gated sinograms.

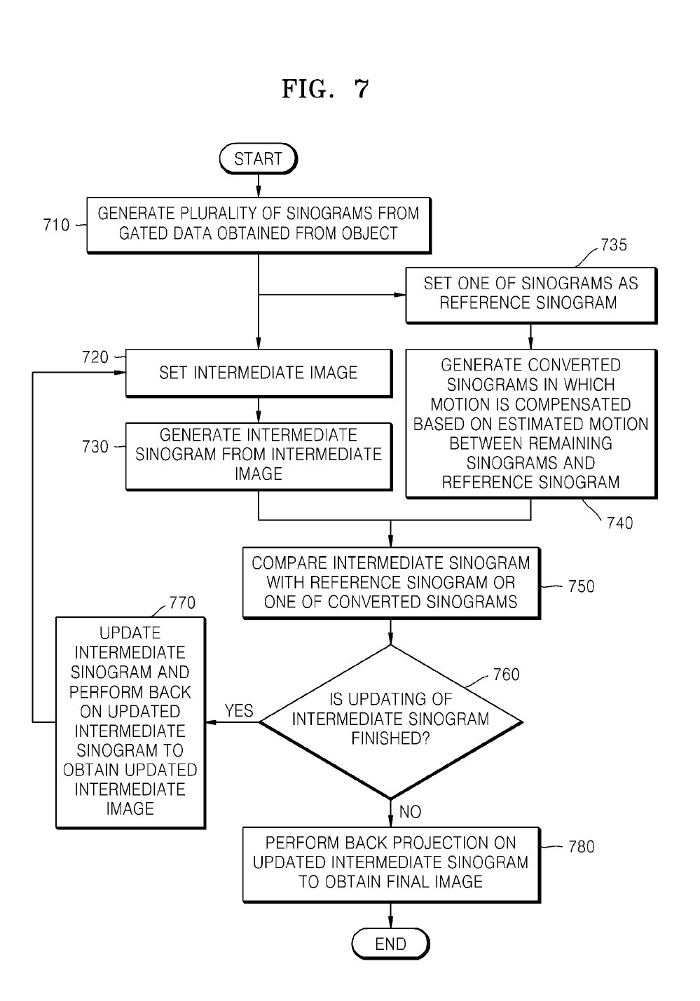

FIG. 7 is a flowchart for explaining an example of a method of generating an image in which motion is compensated performed by the image generation apparatus of FIG. 5. Referring to FIG. 7, the method of generating an image includes operations that are performed in sequence by the image generation apparatus 50 of FIG. 5. Accordingly, the above description of the image generation apparatus 50 is also applicable to the method of generating an image illustrated in FIG. 7, even if the description is not repeated below.

In operation 710, the sinogram generation unit 51 generates a plurality of sinograms from gated data obtained from an object.

In operation 720, the update unit 52 sets an arbitrary image as an intermediate image.

In operation 730, the update unit 52 generates an intermediate sinogram from the intermediate image. The update unit 52 generates the intermediate sinogram by performing a forward projection on the intermediate image.

In operation 735, the update unit 52 sets one of the sinograms obtained in operation 710 as a reference sinogram.

In operation 740, the update unit 52 estimates motion between remaining sinograms of the sinograms obtained in operation 710 and the reference sinogram, and generates converted sinograms in which the motion is compensated. In other words, the update unit 52 converts a remaining sinogram by inversely applying the estimated motion between the remaining sinogram and the reference sinogram to the remaining sinogram. The sinograms are generated based on data in which a location of radiation may vary with a motion of the object. Accordingly, it is necessary to compensate for motion of the location of the radiation by converting the remaining sinograms. Thus, the update unit 52 may compensate for motion of the location of the radiation of the remaining sinograms by estimating a motion of the remaining sinograms and inversely applying the estimated motion to the remaining sinograms.

In operation 750, the update unit 52 compares the intermediate sinogram with the reference sinogram or one of the converted sinograms. The converted sinogram is one of the sinograms in which motion is compensated.

In operation 760, the update unit 52 determines whether updating of the intermediate sinogram is finished. If the updating of the intermediate sinogram is not finished, the update unit 52 proceeds to operation 770. If the updating of the intermediate sinogram is finished, the update unit 52 proceeds to operation 780. Whether the updating of the intermediate sinogram is finished may be determined based on whether a ratio between the intermediate sinogram and the reference sinogram or the converted sinogram is greater than a threshold, or is less or than or equal to the threshold. If the ratio is greater than the threshold, the update unit 52 performs updating. If the ratio is less than or equal to the threshold, the update unit 52 finishes updating.

In operation 770, the update unit 52 updates the intermediate sinogram, and generates an updated intermediate image by performing a back projection on the updated intermediate sinogram. The updated intermediate image is set as the intermediate image in operation 720.

In operation 780, the update unit 52 generates a final image by performing a back projection on the updated intermediate sinogram. If there is little difference between the reference sinogram or the converted sinogram and the updated intermediate sinogram, no more updating is necessary. Thus, the update unit 52 finishes an iterative-reconstruction algorithm and generates a final image by performing a back projection on the currently updated intermediate sinogram to obtain the final image, thus completing the process.

An updated intermediate image is generated by updating a sinogram for an intermediate image in a sinogram domain. Thus, the intermediate image may be updated more effectively than by updating the intermediate image in an image domain.

The image generation apparatus 50, the sinogram generation unit 51, and the update unit 52 illustrated in FIG. 5 and described above that perform the operations illustrated in FIGS. 3, 4, 6, and 7 may be implemented using one or more hardware components, one or more software components, or a combination of one or more hardware components and one or more software components.

A hardware component may be, for example, a physical device that physically performs one or more operations, but is not limited thereto. Examples of hardware components include resistors, capacitors, inductors, power supplies, frequency generators, operational amplifiers, power amplifiers, low-pass filters, high-pass filters, band-pass filters, analog-to-digital converters, digital-to-analog converters, and processing devices.

A software component may be implemented, for example, by a processing device controlled by software or instructions to perform one or more operations, but is not limited thereto. A computer, controller, or other control device may cause the processing device to run the software or execute the instructions. One software component may be implemented by one processing device, or two or more software components may be implemented by one processing device, or one software component may be implemented by two or more processing devices, or two or more software components may be implemented by two or more processing devices.

A processing device may be implemented using one or more general-purpose or special-purpose computers, such as, for example, a processor, a controller and an arithmetic logic unit, a digital signal processor, a microcomputer, a field-programmable array, a programmable logic unit, a microprocessor, or any other device capable of running software or executing instructions. The processing device may run an operating system (OS), and may run one or more software applications that operate under the OS. The processing device may access, store, manipulate, process, and create data when running the software or executing the instructions. For simplicity, the singular term “processing device” may be used in the description, but one of ordinary skill in the art will appreciate that a processing device may include multiple processing elements and multiple types of processing elements. For example, a processing device may include one or more processors, or one or more processors and one or more controllers. In addition, different processing configurations are possible, such as parallel processors or multi-core processors.

A processing device configured to implement a software component to perform an operation A may include a processor programmed to run software or execute instructions to control the processor to perform operation A. In addition, a processing device configured to implement a software component to perform an operation A, an operation B, and an operation C may have various configurations, such as, for example, a processor configured to implement a software component to perform operations A, B, and C; a first processor configured to implement a software component to perform operation A, and a second processor configured to implement a software component to perform operations B and C; a first processor configured to implement a software component to perform operations A and B, and a second processor configured to implement a software component to perform operation C; a first processor configured to implement a software component to perform operation A, a second processor configured to implement a software component to perform operation B, and a third processor configured to implement a software component to perform operation C; a first processor configured to implement a software component to perform operations A, B, and C, and a second processor configured to implement a software component to perform operations A, B, and C, or any other configuration of one or more processors each implementing one or more of operations A, B, and C. Although these examples refer to three operations A, B, C, the number of operations that may implemented is not limited to three, but may be any number of operations required to achieve a desired result or perform a desired task.

Software or instructions for controlling a processing device to implement a software component may include a computer program, a piece of code, an instruction, or some combination thereof, for independently or collectively instructing or configuring the processing device to perform one or more desired operations. The software or instructions may include machine code that may be directly executed by the processing device, such as machine code produced by a compiler, and/or higher-level code that may be executed by the processing device using an interpreter. The software or instructions and any associated data, data files, and data structures may be embodied permanently or temporarily in any type of machine, component, physical or virtual equipment, computer storage medium or device, or a propagated signal wave capable of providing instructions or data to or being interpreted by the processing device. The software or instructions and any associated data, data files, and data structures also may be distributed over network-coupled computer systems so that the software or instructions and any associated data, data files, and data structures are stored and executed in a distributed fashion.

For example, the software or instructions and any associated data, data files, and data structures may be recorded, stored, or fixed in one or more non-transitory computer-readable storage media. A non-transitory computer-readable storage medium may be any data storage device that is capable of storing the software or instructions and any associated data, data files, and data structures so that they can be read by a computer system or processing device. Examples of a non-transitory computer-readable storage medium include read-only memory (ROM), random-access memory (RAM), flash memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, magnetic tapes, floppy disks, magneto-optical data storage devices, optical data storage devices, hard disks, solid-state disks, or any other non-transitory computer-readable storage medium known to one of ordinary skill in the art.

Functional programs, codes, and code segments for implementing the examples disclosed herein can be easily constructed by a programmer skilled in the art to which the examples pertain based on the drawings and their corresponding descriptions as provided herein.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner and/or replaced or supplemented by other components or their equivalents. Therefore, the scope of the disclosure is defined not by the detailed description, but by the claims and their equivalents, and all variations within the scope of the claims and their equivalents are to be construed as being included in the detailed description.

What is claimed is:

1. An image generation method comprising:
classifying data according to a motion period of an object;
generating respective sinograms from the classified data;
updating an intermediate sinogram for an intermediate image using the sinograms;
generating an updated intermediate image by performing a back projection on the updated intermediate sinogram; and
generating an image in which a motion of the object is compensated by sequentially applying the sinograms in a process of generating the updated intermediate image.

2. The image generation method of claim 1, wherein the generating of the updated intermediate image comprises:
setting one of the sinograms as a reference sinogram;
estimating a motion of remaining ones of the sinograms excluding the reference sinogram based on the reference sinogram; and
converting the remaining sinograms by inversely applying the estimated motion to the remaining sinograms;
wherein the updating of the intermediate sinogram comprises updating the intermediate sinogram using the reference sinogram and the converted sinograms.

3. The image generation method of claim 2, wherein the estimating of the motion of the remaining sinograms comprises estimating a degree by which a location of a center for each angle moves in the remaining sinograms relative to the reference sinogram.

4. The image generation method of claim 2, wherein the updating of the intermediate sinogram further comprises:
comparing the intermediate sinogram with the reference sinogram or one of the converted sinograms;
determining whether to update the intermediate sinogram based on a result of the comparing; and
applying a ratio obtained from the result of the comparing to the intermediate sinogram.

5. The image generation method of claim 4, wherein the updating of the intermediate sinogram further comprises determining that the updating of the intermediate sinogram is finished in response to the ratio being less than a predetermined threshold; and
wherein the generating of the image in which the motion of the object is compensated comprises performing a back projection on the updated intermediate sinogram.

6. The image generation method of claim 1, wherein the generating of the respective sinograms comprises:
obtaining the data from a detection unit;
gating the data into 1st through nth groups of data according to the motion period of the object; and
generating 1st through nth sinograms from the 1st through nth groups of data;
wherein the generating of the updated intermediate image comprises sequentially updating the intermediate sinogram using the 1st through nth sinograms.

7. The image generation method of claim 1, wherein the generating of the respective sinograms comprises generating each of the respective sinograms from data of the classified data obtained when a state of the motion of the object is the same.

8. A non-transitory computer-readable storage medium storing a computer for controlling a computer to perform the method of claim 1.

9. An image generation apparatus comprising:
a sinogram generation unit configured to:
classify data according to a motion period of an object; and
generate respective sinograms from the classified data; and
an update unit configured to:
update an intermediate sinogram for an intermediate image using the sinograms;
generate an updated intermediate image by performing a back projection on the updated intermediate sinogram; and
generate an image in which a motion of the object is compensated by sequentially applying the sinograms in a process of generating the updated intermediate image.

10. The image generation apparatus of claim 9, wherein the update unit is further configured to:
set one of the sinograms as a reference sinogram;
estimate a motion of remaining ones of the sinograms excluding the reference sinogram based on the reference sinogram;
convert the remaining sinograms by inversely applying the estimated motion to the remaining sinograms; and
update the intermediate sinogram using the reference sinogram and the converted sinograms.

11. The image generation apparatus of claim 10, wherein the update unit is further configured to estimate the motion of the remaining sinograms by estimating a degree by which a position of a center for each angle moves in the remaining sinograms relative to the reference sinogram.

12. The image generation apparatus of claim 10, wherein the update unit is further configured to update the intermediate sinogram by:
comparing the intermediate sinogram with the reference sinogram or one of the converted sinograms;
determining whether to update the intermediate sinogram based on a result of the comparing; and
applying a ratio obtained from the result of the comparing to the intermediate sinogram.

13. The image generation apparatus of claim 12, wherein the update unit is further configured to:
determine that updating of the intermediate sinogram is finished in response to the ratio being less than a predetermined threshold; and
generate the image in which the motion of the object is compensated by performing a back projection on the updated intermediate sinogram.

14. The image generation apparatus of claim 9, wherein the sinogram generation unit is further configured to:
obtain the data from a detection unit;
gate the data into 1st through nth groups of data according to the motion period of the object; and
generate 1st through nth sinograms from the 1st through nth groups of data; and
wherein the update unit is further configured to sequentially update the intermediate sinogram using the 1st through nth sinograms.

15. The image generation apparatus of claim 9, wherein the sinogram generation unit is further configured to generate each of the respective sinograms from data of the classified data obtained when a state of the motion of the object is the same.

16. An image generation method comprising:
obtaining data from an object;
generating a plurality of sinograms respectively corresponding to different states of the object from the data;
updating an intermediate sinogram based on one or more of the sinograms to obtain an updated intermediate sinogram; and
generating an image by performing a back projection on the updated intermediate sinogram.

17. The image generation method of claim 16, further comprising:
setting one of the sinograms as a reference sinogram;
estimating a change in a state of remaining ones of the sinograms relative to a state of the reference sinogram based on the reference sinogram; and
generating converted sinograms in which the change of the state is compensated by inversely applying the estimated change in the state to the remaining sinograms;
wherein the updating of the intermediate sinogram comprises sequentially updating the intermediate sinogram based on one or more of the reference sinogram and the converted sinograms.

18. The image generation method of claim 17, wherein the sequential updating of the intermediate sinogram comprises:
comparing a latest updated intermediate sinogram produced by a latest updating of the intermediate sinogram in the sequential updating of the intermediate sinogram with a next one of the reference sinogram and the converted sinograms to be used in a next updating of the intermediate sinogram; and
determining whether the sequential updating of the intermediate sinogram is finished based on a result of the comparing.

19. The image generation method of claim 18, wherein the comparing comprises determining a ratio between the latest updated intermediate sinogram and the next one of the reference sinogram and the converted sinograms; and
the determining comprises determining that the sequential updating of the intermediate sinogram is finished in response to the ratio being less than or equal to a predetermined threshold.

20. The image generation method of claim 16, wherein the different states of the object are different motion states of the object; and
the generating of the image produces an image that is compensated for the motion of the object.
